(19) United States
(12) Patent Application Publication
(10) Pub. No.: US 2017/0098961 A1
(43) Pub. Date: Apr. 6, 2017

(54) INDUCTIVE POWER RECEIVER WITH RESONANT COUPLING REGULATOR

(71) Applicant: PowerbyProxi Limited, Freemans Bay, Auckland, NZ (US)

(72) Inventor: Lewis Freeth HARPHAM, Freemans Bay, Auckland (NZ)

(21) Appl. No.: 15/117,061

(22) PCT Filed: Feb. 4, 2015
(86) PCT No.: PCT/NZ15/50007

§ 371 Date: Aug. 5, 2016

(30) Foreign Application Priority Data
Feb. 7, 2014 (NZ) 620979

(51) Int. Cl. H02J 50/12; H02M 7/06; H02J 5/00

(52) U.S. Cl. CPC H02J 50/12; H02J 5/005; H02M 7/066

(57) ABSTRACT

An inductive power receiver including: a resonant circuit having a receiving coil and a tuning network; and rectifier coupled to the resonant circuit and adapted to provide a DC output to a load, wherein the tuning network is controlled to regulate the power provided to the load and includes: a series tuning branch connected from the receiving coil to the rectifier; and a variable shunt tuning branch connected from a node between the series tuning branch and the receiving coil to a common ground on the DC output side of the rectifier.

### FIELD OF THE INVENTION

This invention relates generally to regulating the power provided to a load in an inductive power receiver. More particularly, the invention relates to using a tuning network for regulating power provided to a load.

### BACKGROUND OF THE INVENTION

IPT technology is an area of increasing development and IPT systems are now utilised in a range of applications and with various configurations. Typically, a primary side (i.e. an inductive power transmitter) will include a transmitting coil or coils adapted to generate an alternating magnetic field. This magnetic field induces an alternating current in the receiving coil or coils of a secondary side (i.e. an inductive power receiver). This induced current in the receiver can then be provided to some load, for example for charging a battery or powering a portable device. In some instances, the transmitting coil(s) or the receiving coil(s) may be suitably connected with capacitors to create a resonant circuit. This can increase power throughput and efficiency at the corresponding resonant frequency.

A problem associated with IPT systems is regulating the amount of power provided to the load. It is important to regulate the power provided to the load to ensure the power is sufficient to meet the load's power demands. Similarly, it is important that the power provided to the load is not excessive, which may lead to inefficiencies.

Typically, receivers used in IPT systems consist of: a pickup circuit (e.g. a resonant circuit in the form of an inductor and capacitor); a rectifier for converting the induced power from AC to DC; and a switched-mode regulator for regulating the voltage of the power ultimately provided to a load.

A problem associated with such switched-mode regulators is that they often need to include DC inductors (for example, as used in DC buck converters). Such DC inductors can be relatively large in terms of volume. As there is demand to miniaturise receivers so that they may fit within portable electronic devices, it is desirable that the DC inductor be eliminated from the receiver circuitry.

It is known to regulate power provided to a load by controlling an impedance matching network associated with the receiving coil. Such impedance matching achieves improved power efficiency by matching the impedance of the receiver to the impedance of the transmitter. For example, WO2013/177205 discloses a receiver that includes an impedance matching network that can be controlled to adjust the impedance between a receiving coil and a load inductor. The impedance matching network disclosed is implemented using a Π-coupling network. Such a network relies on two variable shunt branches (e.g. variable capacitors), that are controlled in order to maximise the forward transmission. A problem associated with a Π-coupling network is that having multiple shunt branches requires complex control. Also, each branch includes switches, which contribute further parasitic losses to the receiver circuit. To achieve maximum efficiency, it is desirable to minimise the number of elements that contribute to such parasitic losses.

Accordingly, a device is required for regulating the power provided to the load of an IPT system that is simple to control, and a device that does not include receiver-side DC inductors.

### SUMMARY OF THE INVENTION

According to one exemplary embodiment there is provided an inductive power receiver including: a resonant circuit having a receiving coil and a tuning network; and rectifier coupled to the resonant circuit and adapted to provide a DC output to a load, wherein the tuning network is controlled to regulate the power provided to the load and includes: a series tuning branch connected from the receiving coil to the rectifier; and a variable shunt tuning branch connected from a node between the series tuning branch and the receiving coil to a common ground on the DC output side of the rectifier.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a general representation of an inductive power transfer system according to one embodiment;

FIG. 2 shows a circuit diagram of an inductive power receiver according to one embodiment;

FIG. 3 shows a circuit diagram of an inductive power receiver according to a further embodiment; and

FIG. 4 shows a circuit diagram of an inductive power receiver according to another further embodiment.

### DETAILED DESCRIPTION OF EMBODIMENTS OF THE INVENTION

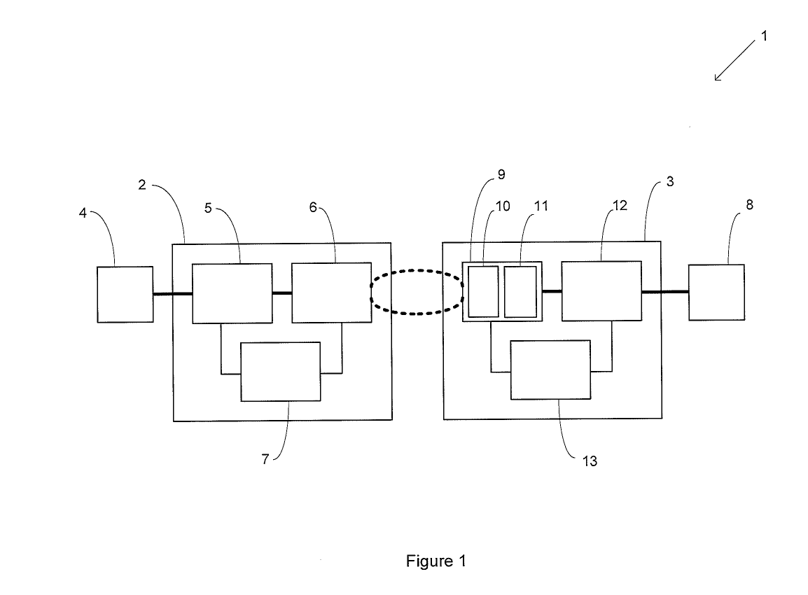

FIG. 1 is a block diagram showing a general representation of an inductive power transfer system 1. The IPT system includes a transmitter 2 and a receiver 3.

The inductive power transmitter 2 is connected to an appropriate power supply 4 (such as mains power). The inductive power transmitter may include transmitter circuitry 5. Such transmitter circuitry includes any circuitry that may be necessary for the operation of the inductive power transmitter. Those skilled in the art will appreciate that this will depend upon the particular implementation of inductive power transmitter, and the invention is not limited in this respect. Without limiting its scope, transmitter circuitry may include converters, inverters, startup circuits, detection circuits and control circuits.

The transmitter circuitry 5 is connected to transmitting coil(s) 6. The transmitter circuitry supplies the transmitting coil(s) with an alternating current such that the transmitting coil(s) generates a time-varying magnetic field with a suitable frequency and amplitude. Where the transmitting coil(s) are part of a resonant circuit, the frequency of the alternating current may be configured to correspond to the resonant frequency. Further the transmitter circuitry may be configured to supply power to the transmitting coil(s) having a desired current amplitude and/or voltage amplitude.

The transmitting coil(s) 6 may be any suitable configuration of coils, depending on the characteristics of the magnetic field that are required in a particular application and the particular geometry of the transmitter. In some IPT systems, the transmitting coils may be connected to other components, such as capacitors, to create a resonant circuit. Where there are multiple transmitting coils, these may be selectively energised so that only transmitting coils in proximity to suitable receiving coils are energised. In some IPT systems, it may be possible that more than one receiver may be powered simultaneously. In IPT systems, where the receivers are adapted to regulate the power provided to the load (as, for example, in the embodiments of the present invention described in more detail below), the multiple transmitting coils may be connected to the same converter. This has the benefit of simplifying the transmitter as it does not need to control each transmitting coil separately. Further, it may be possible to adapt the transmitter so that it controls the power provided to the transmitting coils to a level dependent on the coupled receiver with the highest power demands.

FIG. 1 also shows a controller 7 of the inductive power transmitter 2. The controller may be connected to each part of the inductive power transmitter. The controller may be configured to receive inputs from parts of the inductive power transmitter and produce outputs that control the operation of each part of the transmitter. Those skilled in the art will appreciate that the controller may be implemented as a single unit or separate units. The controller may be a suitable controller that is configured and programmed to perform different computational tasks depending on the requirements of the inductive power transmitter. Those skilled in the art will appreciate that the controller may control various aspects of the inductive power transmitter depending on its capabilities, including for example: power flow (such as setting the voltage supplied to the transmitting coil(s)), tuning, selectively energising transmitting coils, inductive power receiver detection and/or communications.

FIG. 1 also shows a general representation of a receiver 3 according to the present invention. The inductive power receiver is connected to a load 8. As will be appreciated, the inductive power receiver is configured to receive inductive power from the inductive power transmitter 2 and to provide the power to the load. The load may be any suitable load depending upon the application for which the inductive power receiver is being used. For example, the load may be powering a portable electronic device or may be a rechargeable battery. The power demands of a load may vary, and therefore it is important that the power provided to the load matches the load's power demands. In particular, the power must be sufficient to meet the power demands whilst not being too excessive (which may lead to inefficiencies).

The receiver 3 includes a resonant circuit 9 that includes a receiving coil 10 and a tuning network 11. As will be appreciated, when the receiving coil is suitably coupled to the transmitting coil 6 of the transmitter 2, an AC voltage is induced across the receiving coil resulting in an AC current. Ultimately this power is provided to the load 8. The configuration of the receiving coil will vary depending on the characteristics of the particular IPT system for which the receiver is used, and the invention is not limited in this respect.

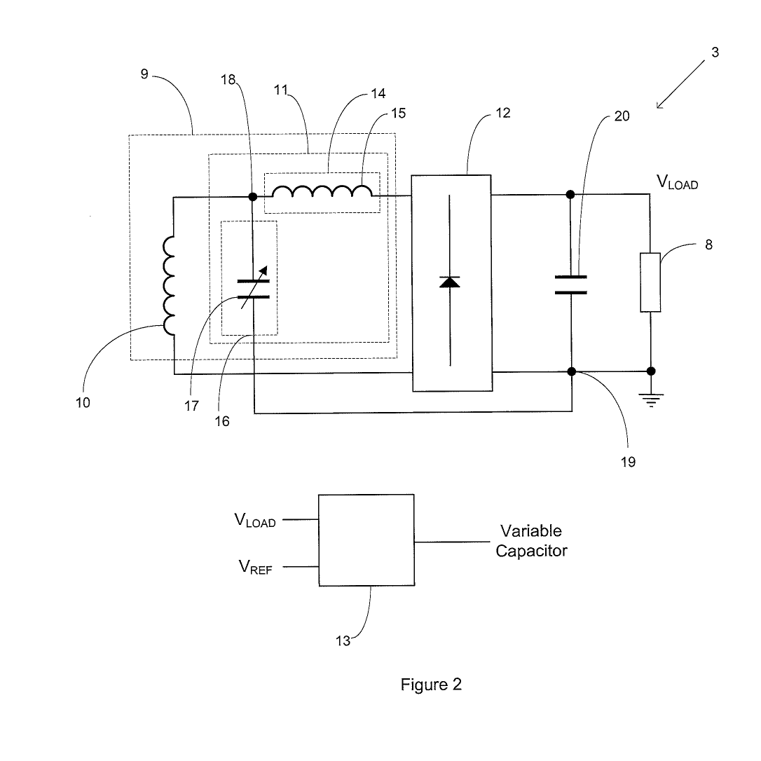

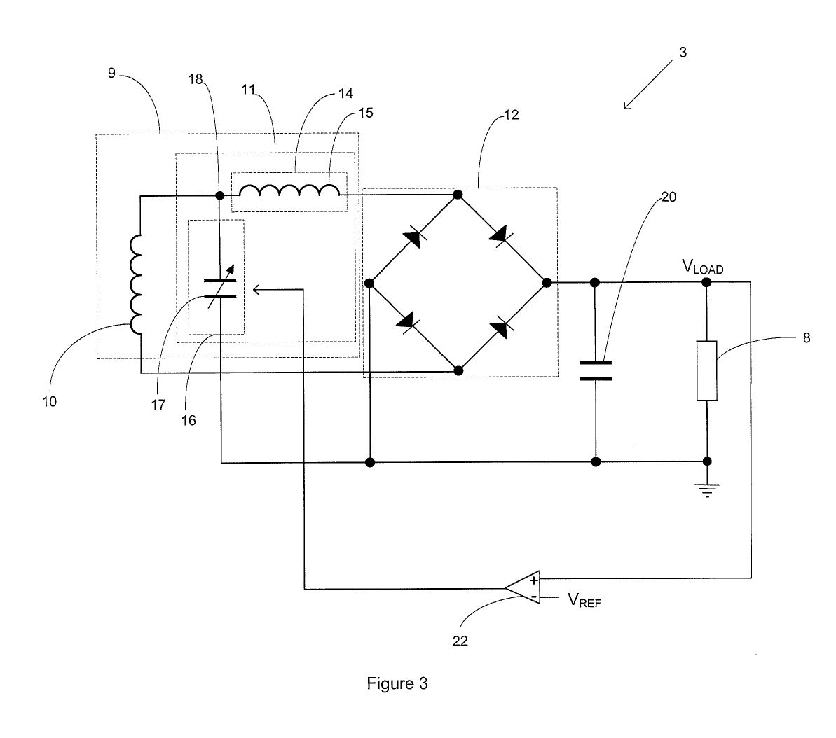

The tuning network 11 is configured to adjust the impedance of the resonant circuit 9 and thus adjust the power received by the receiver 3 and provided to the load 8. The details of a specific embodiment of a tuning network will be discussed in more detail in relation to FIGS. 2 and 3 below.

The resonant circuit 9 of the receiver is connected to a rectifier 12. The rectifier is configured to rectify the AC power of the resonant circuit to DC power that may be provided to the load 8. Those skilled in the art will appreciate that there are many types of rectifier that may be used, and the invention is not limited in this respect. In one embodiment, the rectifier may be a diode bridge. In another embodiment, the rectifier may consist of an arrangement of switches that may be actively controlled resulting in synchronous rectification.

FIG. 1 further shows a controller 13 of the inductive power receiver 3. The controller may be connected to each part of the inductive power receiver. The controller may be configured to receive inputs from parts of the inductive power receiver and produce outputs that control the operation of each part. In particular, the controller may control the tuning network as will be described in more detail below. Those skilled in the art will appreciate that the controller may be implemented as a single unit or separate units. The controller may be a suitable controller that is configured and programmed to perform different computational tasks depending on the requirements of the inductive power receiver. Those skilled in the art will appreciate that the controller may control various aspects of the inductive power receiver depending on its capabilities, including for example: power flow, impedance matching/tuning (as will be described in more detail below), and/or communications.

Having discussed an IPT system 1 in general (above), it is helpful to now discuss a particular embodiment of the inductive power receiver 3 according to the present invention as shown in FIG. 3. The inductive power receiver includes the resonant circuit 9 which has a receiving coil 10 and a tuning network 11. As discussed above in relation to FIG. 1, the receiving coil is configured to couple to one or more transmitting coils of the power transmitter.

The tuning network includes a series tuning branch 14 connected from the receiving coil 10 to the rectifier 12. In this particular embodiment, the series tuning branch is an inductor 15. However, it is possible that the series tuning branch may be a capacitor. The series tuning branch works in concert with a shunt tuning branch 16 to transmit power to the load (described in detail below). Similarly, the receiving coil 10 functions as an input series tuning 1(:) branch that can also work in concert with the shunt tuning branch 16. Thus there are two circulating power flow paths: one that circulates from the resonant circuit 9 back towards the transmitter (not shown) and a second that circulates from the resonant circuit 9 towards the load 8.

Those skilled in the art will recognise these two power flows as a forward transmissive power wave and a reverse reflective power wave, commonly characterized through the use of Scattering Parameter measurements which when manipulated mathematically in s-parameter matrix sets enable the computation of the bidirectional reflection and transmission coefficients in a single discrete stand-alone concurrent operation.

The ability to pass part of the incident power to the load and to return the unused part of the incident power to the transmitter results in higher overall system efficiency. This is due to the re-use of the reflected power when used as part of a resonant transmitter/receiver system—the transmitter can then be made to behave in a similar fashion returning the unused power back to the receiver. The energy being passed back and forward is then stored in the resonant coupling between the receiver and transmitter. The energy is stored predominantly in the air-gap due to the transmitting coil inductance, receiving coil inductance and the capacitance from the electric field used to maintain resonance. In the case of the present tuning network 11 included in a receiver, it is possible to control how much of the power is reflected back or transmitted through.

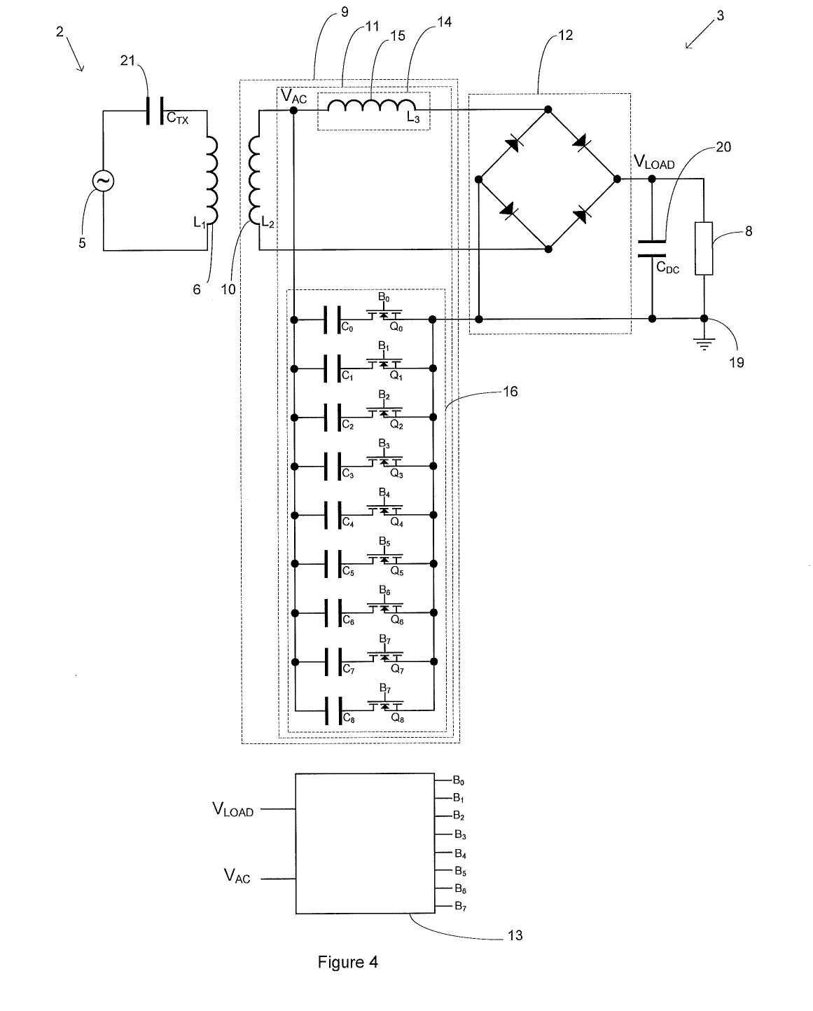

The tuning network 11 also includes the shunt tuning branch 16 connected from node 18 between the receiving coil 10 and the series tuning branch 14 to ground 19 on the DC output side of the rectifier 12. In this particular embodiment, the shunt tuning branch 16 is a variable capacitor 17. Such a variable capacitor may be implemented as a bank of capacitors (as discussed below in relation to FIG. 4). In one embodiment, the variable capacitor may be a relatively large capacitor connected to a switch, with the switch driven by a PWM signal to effect linear control of the capacitance. It is possible that the variable shunt tuning branch may alternatively be a variable inductor.

As will be explained in more detail below, the impedance of this variable shunt tuning branch may be controlled to change the tuning of the resonant circuit. Effectively, this regulates the power provided to the load since by changing the tuning of the resonant circuit, the receiver will receive more or less power (depending on whether the change in impedance brings the resonant circuit closer to or further away from resonance) and thus the power provided to the load will be regulated. Further, the change of impedance in the tuning network will result in a change in the impedance reflected to the transmitting coil. Such reflected impedance will affect the amount of power transmitted by the transmitting coil and thus the power provided to the load will be regulated.

It will be appreciated that the resonant circuit 9 (i.e. the receiving coil 10 and the tuning network 11) may be considered to form a T-coupling network.

The power received by the resonant circuit 9 is supplied to the rectifier 12. As discussed above in relation to FIG. 1, the rectifier is configured to rectify the AC power of the resonant circuit to a DC power that may be provided to the load 8. The DC output of the rectifier may be further conditioned by a DC smoothing capacitor 20.

The inductive power receiver 3 further includes the controller 13. The controller is configured to determine the voltage supplied to the load 8 (V_{LOAD}). This voltage is compared to a suitable reference voltage (V_{REF}). From this comparison the controller determines whether more or less power needs to be provided to the load, and accordingly produces an output to control the variable shunt tuning branch. In one embodiment, the controller may be implemented as a suitably configured PI or PID controller with an associated analogue to digital converter. Those skilled in the art understand that other implementations for the controller are possible.

It will be appreciated from FIG. 2 that the receiver does not require a separate regulating stage, as is conventional, since such regulation is achieved by controlling the variable shunt tuning branch 16. In particular, the receiver does not include a DC inductor (as for example would be used in a conventional DC buck regulator).

FIG. 3 shows a particular embodiment of the inductive power receiver 3 discussed in relation to FIG. 2. In this embodiment, the rectifier 12 is a full diode bridge. The variable capacitor 17 is controlled from a comparator 22, that is configured to compare the output voltage (V_{LOAD}) to a reference voltage (V_{REF}) and control the capacitor accordingly.

FIG. 4 shows a particular embodiment of the IPT system 1 discussed in relation to FIG. 1 including a more particular embodiment of the inductive power receiver discussed in relation to FIG. 2. In FIG. 4 like reference numerals are used to designate like components. Example component values of the components illustrated in FIG. 4 are shown in Table 1 below:

TABLE 1

| Component | Value | |
|---|---|---|
| L₁ | 15 | microH |
| L₂ | 10 | microH |
| L₃ | 11 | microF |
| C_{Tx} | 180 | nF |
| C_{DC} | 470 | microF |
| C₀ | 1.5 | nF |
| C₁ | 3 | nF |
| C₂ | 6 | nF |
| C₃ | 12 | nF |
| C₄ | 24 | nF |
| C₅ | 48 | nF |
| C₆ | 96 | nF |
| C₇ | 96 | nF |
| C₈ | 96 | nF |

With these component values, the IPT system has a resonant frequency of approximately 110 kHz. Therefore, the transmitter circuitry 5 will generate an alternating current at around 110 kHz. This generated current is provided to the transmitting coil 6, L₁, which is series resonant with a capacitor 21, C_{TX}. In another embodiment, it may be possible to have a non-resonant transmitting coil.

The resonant circuit 9 of the receiver 3 includes the receiving coil 10, L₂, and the tuning network 11. The tuning network includes the series tuning branch 14 in the form of the inductor 15, L₃, and the variable shunt tuning branch 16 in the form a capacitor bank. The resonant circuit is connected to the rectifier 12 which outputs a direct current to the load 8. The rectifier is shown as a diode bridge, however those skilled in the art understand that other implementations are possible. The DC output of the rectifier may be further conditioned by the DC smoothing capacitor 20.

The capacitor bank 16 is controlled to provide a variable impedance. The capacitor bank includes an array of capacitors, C₀-C₈, that may be selectively switched into or out of the shunt branch via associated control switches, Q₀-Q₈, to adjust the amount of capacitance in the variable shunt tuning branch, and thus adjust the impedance of the tuning network 11. As indicted in Table 1, the capacitance values of C₀-C₈ vary, for reasons discussed below. By having the capacitor bank referenced to ground 19 the control of the capacitor bank is simplified since each control switch is not floating. If the Q value of the smoothing capacitor 20 is relatively small compared to the Q values of the components of the resonant circuit (e.g. the receiving coil and the series tuning inductor), then any losses due to alternating current flowing into the DC capacitor will be acceptably small. In this embodiment, the control switches are n-channel MOSFETs, however the invention is not limited in this respect and it will be appreciated that the capacitor bank may be configured with other types of switches. Whilst a capacitor bank is preferable over an analogue variable capacitor since it is more cost effect and much simpler to control, the invention is not limited to this implementation.

The controller 13 compares the voltage supplied to the load (V_{LOAD}) to a reference voltage (V_{AC}). The controller may be suitably configured to detect when the voltage supplied to the load falls above or below the reference voltage. In this way, the controller acts as a feedback controller. The controller is configured to generate a parallel digital output (B₀-B₇) that controls each of the control switches (Q₀-Q₈), and thus control each of the capacitors in the capacitor bank. The controller may be configured to operate at any reasonable frequency from being static (i.e. DC) through to a multiple of the resonant frequency. It will be appreciated that configuring the capacitors in the capacitor bank to have the range of capacitances discussed above (as opposed to all having the same capacitance) allows for a wider range of control to be achieved. In one embodiment, the controller may be implemented as a suitably configured PI or PID controller with an associated analogue to digital converter. Those skilled in the art understand that other implementations for the controller are possible.

The degree of resolution of control of the capacitor bank is dictated by the resolution of digital output from the controller. By increasing the number of digital outputs, the controller tends towards fully-analogue control. However, the benefit of implementing coarse control (that is to say, non-analogue control) is that for minor fluctuations in the load, there will be no change in the switches associated with the capacitors. Therefore, under steady state conditions, the output from the controller becomes static which leads to operational stability. This minimises losses that would otherwise occur as switches were constantly switched to accommodate minor fluctuations in the load.

Those skilled in the art understand that the various embodiments described herein and claimed in the appended claims provide a utilisable invention and at least provide the public with a useful choice.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power receiver including:
a. a resonant circuit having a receiving coil and a tuning network; and
b. rectifier coupled to the resonant circuit and adapted to provide a DC output to a load,
wherein the tuning network is controlled to regulate the power provided to the load and includes:
i. a series tuning branch connected from the receiving coil to the rectifier; and
ii. a variable shunt tuning branch connected from a node between the series tuning branch and the receiving coil to a common ground on the DC output side of the rectifier.

2. The inductive power receiver as claimed in claim 1, wherein the series tuning branch is an inductor.

3. The inductive power receiver as claimed in claim 1, wherein the series tuning branch is a capacitor.

4. The inductive power receiver as claimed in claim 1, wherein the variable shunt tuning branch is a variable capacitor.

5. The inductive power receiver as claimed in claim 4, wherein the variable capacitor is a capacitor bank.

6. The inductive power receiver as claimed in claim 2, wherein the variable shunt tuning branch is a variable inductor.

7. The inductive power receiver as claimed in claim 1, further including a DC smoothing capacitor for smoothing the DC output provided to the load.

8. The inductive power receiver as claimed in claim 7, wherein the Q value of the DC smoothing capacitor is relatively small compared to the Q values of the components of the resonant circuit.

9. The inductive power receiver as claimed in claim 1, wherein the series tuning branch is an inductor and the variable shunt tuning branch is a variable capacitor.

10. The inductive power receiver as claimed in claim 1, wherein the series tuning branch is an capacitor and the variable shunt tuning branch is a variable capacitor.
